(19) United States
(12) Patent Application Publication
(10) Pub. No.: US 2017/0110127 A1
(43) Pub. Date: Apr. 20, 2017

(54) DIALOGUE SUPPORT APPARATUS AND METHOD

(71) Applicant: KABUSHIKI KAISHA TOSHIBA, Tokyo (JP)

(72) Inventor: Hiroko Fujii, Komae Tokyo (JP)

(21) Appl. No.: 15/392,411

(22) Filed: Dec. 28, 2016

Related U.S. Application Data
(63) Continuation of application No. PCT/JP2015/059528, filed on Mar. 20, 2015.

(30) Foreign Application Priority Data
Sep. 17, 2014 (JP) 2014-189320

(51) Int. Cl. G10L 15/22; G06F 17/27; G06F 17/24

(52) U.S. Cl. CPC G10L 15/22; G06F 17/24; G06F 17/279; G10L 15/265

(57) ABSTRACT

According to one embodiment, a dialogue support apparatus includes a receiver, a processor, a storage, a detector, a specifying unit, a first updating unit and a second updating unit. The receiver receives at least one input information indicating a user's intention. The storage stores a dialogue history indicating a history of the input information and a system response. The detector detects a user operation performed by the user. The specifying unit specifies the input information and the system response in the dialogue history to which the user operation is performed if the user operation is associated with a predetermined function. The first updating unit updates the dialogue history. a second updating unit that updates a user interface according to the dialogue history updated by the first updating unit.

### CROSS-REFERENCE TO RELATED APPLICATIONS

This application is a Continuation application of PCT Application No. PCT/JP2015/059528, filed Mar. 20, 2015 and based upon and claiming the benefit of priority from Japanese Patent Application No. 2014-189320, filed Sep. 17, 2014, the entire contents of which are incorporated herein by reference.

### FIELD

Embodiments described herein relate generally to a dialogue support apparatus and method.

### BACKGROUND

Along with the rapid popularization of small mobile terminals such as smartphones, the importance of dialogue systems allowing natural speech inputs has increased. The dialogue systems allowing natural speech inputs interpret a user's intention without the need for users to adapt their speech to the dialogue systems. That is, users do not have to use predefined phrases, but can give instructions to the system in their own words. Such dialogue systems reduce the burden on the user. On the other hand, there are cases where the dialogue systems fail to correctly interpret a user's intention from a user's utterance. If the systems interpret the user's intention incorrectly, the systems proceed with incorrect dialogue processing. This requires the processing to undo the previous dialogue status.

A technique for undoing the previous dialogue status by using a set of recognized words instead of the user's utterance of “undo” has been used.

### BRIEF DESCRIPTION OF THE DRAWINGS

FIG. 1 is a conceptual drawing showing an example of a dialogue system on which the embodiment is based.

FIG. 2 is a block diagram showing a dialogue support apparatus.

FIG. 3 illustrates an example of a function specification table.

FIG. 4 is a flowchart showing the operation of the dialogue support apparatus.

FIG. 5 illustrates an example of an interface window.

FIG. 6 illustrates a first example of a user's operation.

FIG. 7 illustrates a processing result in response to the first example of the user's operation.

FIG. 8 illustrates a second example of a user's operation.

FIG. 9 illustrates a processing result in response to the second example of the user's operation.

FIG. 10 illustrates a third example of a user's operation.

FIG. 11 illustrates a processing result in response to the third example of the user's operation.

FIG. 12 illustrates a fourth example of a user's operation.

FIG. 13 illustrates a processing result in response to the fourth example of the user's operation.

### DETAILED DESCRIPTION

The technique for undoing the last dialogue status can be applied only when words in the user's speech are predetermined. With such a technique, the dialogue status can undo only the last dialogue status. That is, if an incorrect interpretation is found in a specific dialogue step before the last dialogue, the aforementioned technique cannot undo the specific dialogue step.

In addition, for a searching processing such as searching for a TV program by dialogue with the dialogue system, a user needs to repeatedly input similar conditions even if the previously input conditions can be used for a new search. For example, if the user wants to search for programs with conditions (i) will be broadcast next week, (ii) will be broadcast on a specific channel, e.g., XX TV, and (iii-a) Mr. A appears, and programs with conditions (i) will be broadcast next week, (ii) will be broadcast on XX TV, and (iii-b) Ms. B appears, the user has to input the first two conditions (i) and (ii) twice. This is inconvenient for the user.

In general, according to one embodiment, a dialogue support apparatus includes a receiver, a processor, a storage, a detector, a specifying unit, a first updating unit and a second updating unit. The receiver receives at least one input information item indicating a user's intention. The processor uses a dialogue processing system interpreting the user's intention and performing a process corresponding to the user's intention, and obtains at least one system response each indicating a response of the dialogue processing system to the input information item. The storage stores a dialogue history indicating a history of the input information item and the system response. The detector detects a user operation performed by the user. The specifying unit specifies the input information item and the system response in the dialogue history to which the user operation is performed if the user operation is associated with a predetermined function. The first updating unit updates the dialogue history in response to execution of the function corresponding to the at least one of the input information item and the system response specified by the specifying unit. The second updating unit updates a user interface (UI) in accordance with the dialogue history updated by the first updating unit.

In the following, the dialogue support apparatus and method according to the present embodiment will be described in details with reference to the drawings. In the embodiment described below, elements specified by the same reference numbers carry out the same operation, and a duplicate description of such elements will be omitted.

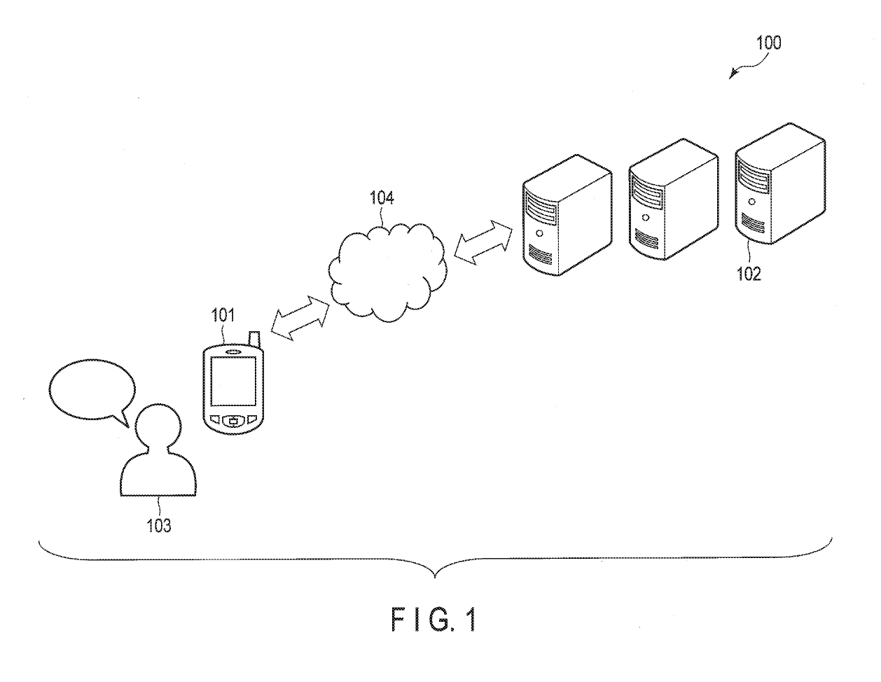

An example of a dialogue system on which the embodiment is based will be explained with reference to the conceptual drawing of FIG. 1.

A dialogue system 100 shown in FIG. 1 includes a terminal 101 and a server 102. The terminal 101 may be a tablet PC or a mobile phone such as a smartphone used by a user 103. In the present embodiment, the user 103 inputs an utterance to a client application loaded in the terminal 101, and the terminal 101 performs a speech recognition to obtain a speech recognition result.

The server 102 is connected to the terminal 101 through a network 104, receives the speech recognition result from the terminal 101, and performs dialogue processing in response to the speech recognition result.

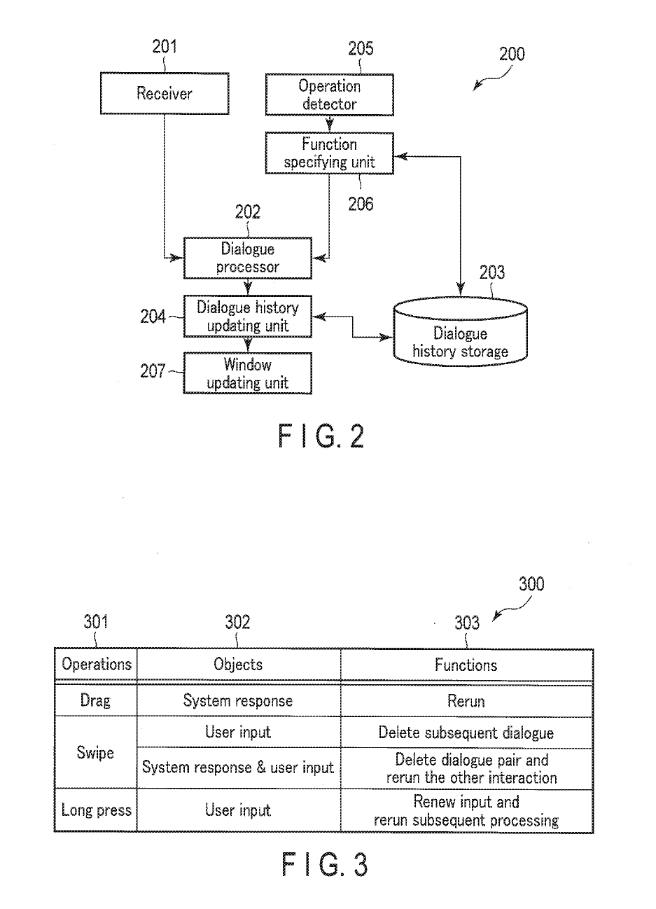

Next, the dialogue support apparatus according to the embodiment will be explained with reference to the block diagram of FIG. 2.

A dialogue support apparatus 200 according to the embodiment includes a receiver 201, a dialogue processor 202, a dialogue history storage 203, a dialogue history updating unit 204, an operation detector 205, a function specifying unit 206, and a user interface updating unit 207. The dialogue support apparatus 200 is loaded in the terminal 101 shown in FIG. 1, for example.

The receiver 201 receives a user's utterance as an audio signal, and generates text as a result of speech recognition of the audio signal. The text obtained as a result of speech recognition may also be called user input information describing a user's intention. For example, a user's utterance input to a microphone loaded in the terminal 101 shown in FIG. 1 may be received as an audio signal. The speech recognition processing may be performed by using a speech recognition server (not shown in the drawings) in a cloud computing configuration, or by using a speech recognition engine within a terminal. The receiver 201 may receive text that the user directly inputs by means of a keyboard as user input information.

The dialogue processor 202 receives the text obtained as a result of speech recognition from the receiver 201, and performs a dialogue processing to the received text. In the present embodiment, the dialogue processor 202 generates a request message including a request for processing the text obtained as the result of speech recognition, and transmits the request message to an external dialogue processing server such as the server 102 shown in FIG. 1. The dialogue processing server interprets a user's intention included in the request message, performs processing in response to the user's intention, and generates a processing result. The dialogue processor 202 receives a response message including the processing result from the dialogue processing server, the processing result including a text (hereinafter referred to also as “system response”) obtained by processing the user input information. When a dialogue processing engine is provided within a terminal in which the dialogue support apparatus 200 is loaded, the dialogue processing may be performed within the terminal by using the dialogue processing engine. If a specified user input information and system response are received from the function specifying unit 206 explained later, a request message is generated in accordance with a function specified by the function specifying unit 206.

The dialogue history storage 203 stores a dialogue history indicating a history of dialogue between the user and the system. The dialogue history includes user input information, a system response obtained as a result of processing relative to each user input information, and identifiers of user input information and system responses. The user input information, system responses, and identifiers thereof are associated with each other.

The dialogue history updating unit 204 receives user input information and a system response from the dialogue processor 202, and updates the dialogue history stored in the dialogue history storage 203 in accordance with at least one of user input information and the system response.

The operation detector 205 detects an operation that the user performs on an interface window as a user's operation. Specifically, the operation detector 205 detects an operation such as a swipe operation in which the user traces text in the dialogue history displayed in the interface window, or a drag operation in which the user designates and moves elements displayed in the interface window by touching and holding a certain part of the window and moving it to a different location in the interface window.

The function specifying unit 206 receives the user's operation from the operation detector 205, and determines whether or not the received user's operation is associated with a predefined dialogue processing function by referring to a function specification table explained later with reference to FIG. 3. If the user's operation is associated with the predefined dialogue processing function, the function specifying unit 206 specifies at least one of an item of the user input information and an item of the system response designated by the user's operation to which the function is performed.

The window updating unit 207 updates an UI based on the dialogue history updated by the dialogue history updating unit 204.

An example of a function specification table stored in the function specifying unit 206 will be explained with reference to FIG. 3.

The function specification table 300 shown in FIG. 3 associates operations 301, objects 302, and functions 303 with one another.

The operation 301 indicates an operation that the user performs on the interface window. The object 302 is an object of the user's operation, i.e., user input information or a system response. The function 303 indicates a processing to be performed.

For example, the operation 301, “dragging,” the object 302, “system response,” and the function 303, “rerun” are associated with each other.

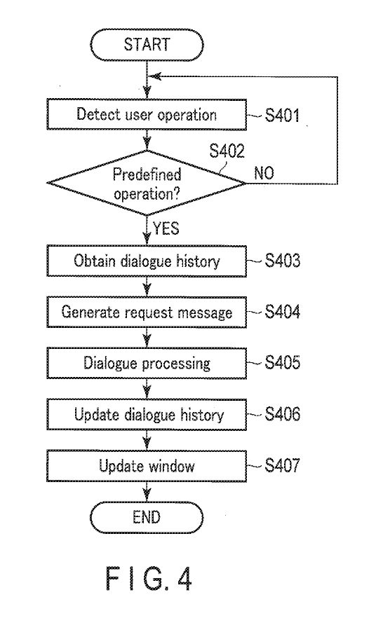

Next, the operation of the dialogue support apparatus 200 according to the embodiment will be explained with reference to the flowchart shown in FIG. 4.

In step S401, the operation detector 205 detects a user's operation on the interface window.

In step S402, the function specifying unit 402 determines whether or not the user's operation is predefined by referring to the function specification table. If the user's operation is predefined, step S403 is executed; if not, the processing returns to step S401 in order to repeat the same processing.

In step S403, the function specifying unit 206 obtains an identifier associated with the object of the user's operation from the dialogue history storage 203.

In step S404, the dialogue processor 202 generates a request message.

In step S405, the dialogue processor 202 performs dialogue processing. It is assumed that the request message is sent to the dialogue processing server, and a response message that is a result of the dialogue processing is received.

In step S406, the dialogue history updating unit 204 updates the dialogue history in response to the user input information or the system response included in the response message to which the dialogue processing is performed.

In step S407, the window updating unit 207 updates the dialogue history displayed on the interface window in accordance with the updated dialogue history. The operation of the dialogue support apparatus 200 is completed by the above processing.

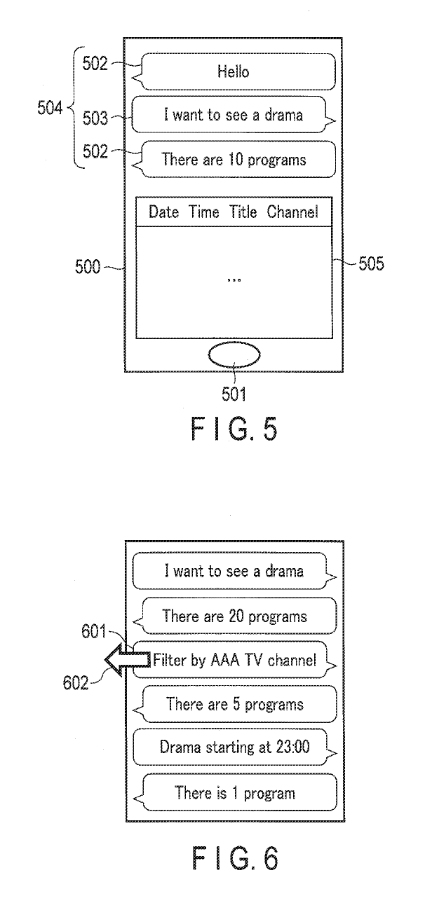

An example of an interface window will be explained with reference to FIG. 5.

FIG. 5 shows an example of interface window 500. Dialogue between the user and the system starts when the user presses or touches a speech recognition initiation button 501 to cause the receiver 201 to acquire an utterance of the user.

The user input information is represented by reference numeral 503, and the system response is represented by reference numeral 502. The user input information 503 and the system response 502 may be distinguished by changing the direction or color of dialogue balloons. The user input information 503 and the system response 502 are shown on a dialogue content display area 504 in the sequential order of dialogue. The old dialogue history can be shown by scrolling or changing pages of the dialogue content display area 504.

The dialogue processing results are shown on a processing result display area 505. In FIG. 5, in response to user input information 503, “I want to see a drama”, a list of TV programs is shown on the processing result display area 505 as a dialogue processing result.

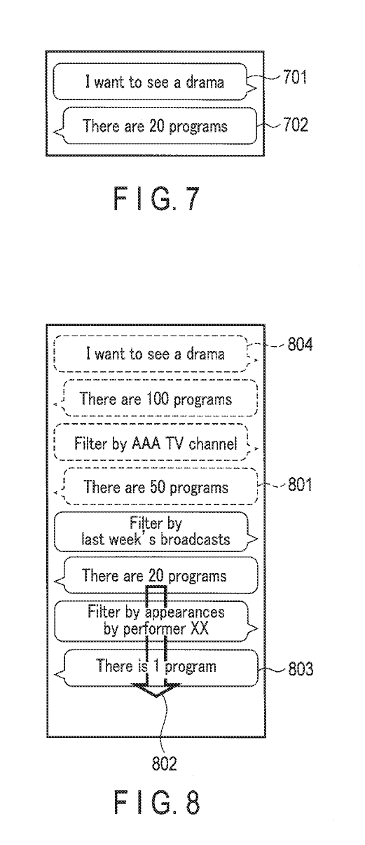

The first example of a user's operation will be explained with reference to FIGS. 6 and 7.

In the following explanation of the function, it is assumed that a user performs an operation in relation to the currently executing task. When the user uses the previously completed task, the system may rerun the dialogue processing as explained in the second example, which will be described later, to make the previously completed task be active again.

FIG. 6 is an example of a dialogue history displayed on the interface window. This example is for a case where a swiping operation, in which the user touches the screen and slides a pointing means in the right or left direction, is associated with a function of “deleting the designated user input information and dialogue after the designated user input information” (“delete subsequent dialogue” in FIG. 3) in the function specification table used at the function specifying unit 206. It is assumed that the user swipes user input information 601, “Filter by AAA TV channel”, from which the user wants to delete the dialogue, in the direction of arrow 602.

The operation detector 205 detects the swiping operation, and the function specifying unit 206 determines that a function corresponding to the swiping operation is “deleting the designated user input information and dialogue after the designated user input information” by referring to the function specification table.

The function specifying unit 206 acquires an identifier corresponding to the user input information 601 which the user has swiped from the dialogue history storage 203. The dialogue processor 202 generates a request message indicating deletion of the designated user input information and dialogue after the designated user input information, based on the function and the identifier of the object of the function.

The dialogue processor 202 transmits the request message to the dialogue processing server, and receives a response message indicating completion of deleting the designated user input information and dialogue after the designated user input information from the dialogue processing server. The dialogue history updating unit 204 deletes the dialogue from the user input information, and text 601 from the dialogue history stored in the dialogue history storage 203, in response to the response message. The window updating unit 207 deletes the dialogue from user input information 601 and onward from the dialogue content display area 504.

FIG. 7 shows the processing result after the system executes the function indicated in the first example.

As shown in FIG. 7, the dialogue content display area 504 only shows the last user input information 701, “I want to see a drama”, and system response 702, “There are 20 programs”, which is a response to the user input information 701, before the designated user input information 601. With this function, the user can only leave a required dialogue by a swiping operation.

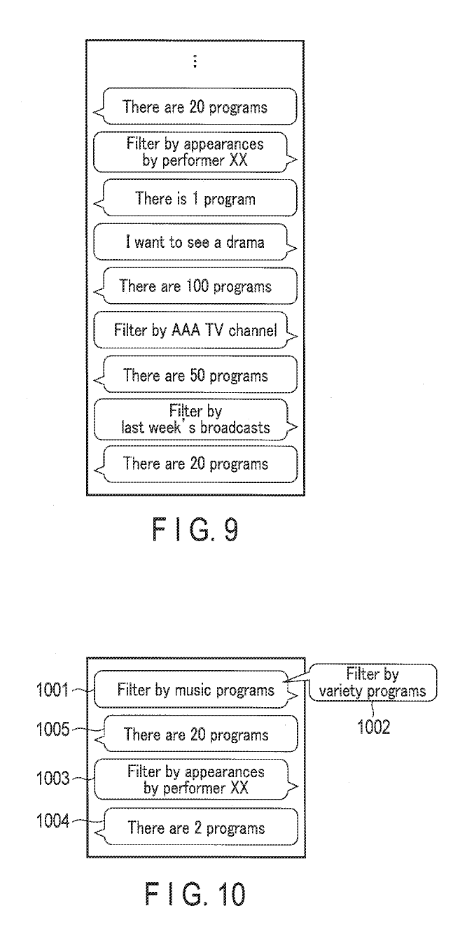

The second example of a user's operation will be explained with reference to FIGS. 8 and 9.

FIG. 8 is an example of a dialogue history displayed on the interface window, which is the same as in FIG. 6. In the function specification table, a dragging operation, in which the user moves a pointing means while touching the screen by the pointing means, is associated with a function of “reproduce the dialogue status immediately after the designated system response was shown” (“rerun” in FIG. 3), i.e., rerunning the dialogue processing to the designated system response to set the dialogue status of the dialogue history when the designated system response was shown as a present status. It is assumed that the user drags a system response 801, “There are 20 programs”, to the final text displayed on the interface window in the direction of arrow 802.

The operation detector 205 detects the dragging operation, and the function specifying unit 206 determines that a function corresponding to the dragging operation is, “Reproduce the dialogue status immediately after the designated system response was shown”, by referring to the function specification table.

The function specifying unit 206 acquires an identifier corresponding to the system response 801 that the user has dragged from the dialogue history storage 203. The dialogue processor 202 generates a request message indicating reproduction of the dialogue status immediately after the designated system response was shown, based on the function and the identifier of the object of the function.

The dialogue processor 202 transmits the request message to the dialogue processing server, and receives from the dialogue processing server a response message indicating completion of reproduction of the dialogue status immediately after the designated system response is shown. The response message includes information (text and identifiers corresponding to the user input information and system response) corresponding to the user input information resubmitted to reproduce the dialogue status designated by the user. FIG. 8 shows the following dialogue:

User input information: I want to see a drama
System response: There are 100 programs
User input information: Filter by AAA TV channel
System response: There are 50 programs
User input information: Filter by last week's broadcasts
System response: There are 20 programs
User input information: Filter by appearances by performer XX
System response: There is 1 program

If the user drags the system response 801, “There are 20 programs”, to below the last system response 803, “There is 1 program”, the dialogue processing server reproduces the dialogue status when the user input information 804, “I want to see a drama”, was displayed, and the dialogue processing responsive to the user input information, “I want to see a drama”, “Filter by AAA TV channel” and “Filter by last week's broadcasts”, is sequentially performed again. Then, the dialogue status in the dialogue processing server is able to undo the status displaying the system response 801. That is, the response message includes the following rerun information:

User input information: I want to see a drama
System response: There are 100 programs
User input information: Filter by AAA TV channel
System response: There are 50 programs
User input information: Filter by last week's broadcasts
System response: There are 20 programs

The dialogue history updating unit 204 adds the rerun information at the end of the dialogue history stored in the dialogue history storage 203, in response to the response message. The window updating unit 207 adds the rerun information after the system response 803.

FIG. 9 shows the processing result after the system executes the function indicated in the second example.

As shown in FIG. 9, the dialogue designated by the user is shown immediately after the last dialogue shown at the time when the user operation is performed. Accordingly, the user can easily compare the processing results obtained by partially changing the input conditions.

The third example of a user's operation will be explained with reference to FIGS. 10 and 11.

FIG. 10 is an example of a dialogue history displayed in the interface window. This example is for the case where a long pressing operation in which the user presses and holds the screen over a predetermined time is associated with a function of “replacing the designated user input information with newly input user input information, and rerunning the dialogue processing after the designated user input information as much as possible” (“renew input and rerun subsequent processing” in FIG. 3) in the function specification table used at the function specifying unit 206. It is assumed that the user presses and holds user input information 1001, “Filter by music programs”, that the user wants to renew.

Upon detection of the long pressing operation by the operation detector 205, the function specifying unit 206 determines a function corresponding to the long pressing operation is “replacing the designated user input information with newly input user input information, and rerunning the dialogue processing after the designated user input information as much as possible” by referring to the function specification table.

The function specifying unit 206 acquires an identifier corresponding to the user input information 1001, which the user has pressed and held from the dialogue history storage 203. The receiver 201 receives a new input from the user. The dialogue processor 202 generates a request message based on the corresponding function, the identifier of the object of the function, and the user input information newly input by the user.

The dialogue processor 202 transmits the request message to the dialogue processing server, and receives a response message from the dialogue processing server. The received response message includes processing results in response to the request. If the function is successfully completed, the response message includes the renewed user input information and the results of processing the user input information that was already input before renewal of the user input information.

In the example shown in FIG. 10, it is assumed that the user inputs an instruction to change user input information 1001, “Filter by music programs”, to “Filter by variety programs”, after a system response 1004 is displayed in response to the user input information 1003, “Filter by appearances by performer XX”. In response to the instruction, the dialogue processing server cancels the dialogue ascending to the user input information that the user renewed and processes the renewed user input information 1002, “Filter by variety programs”. Then, the server determines whether or not the user input information 1003, “Filter by appearances by performer XX”, which was input before renewal of the user input information 1001, can be processed, and proceeds with the user input information 1003 again when it is processable. In this example, since the user input information before and after renewal is both for filtering, rerunning of the user input information that has already input before renewal can be performed. If the dialogue scenario is changed by renewal of the user input information, rerunning is not performed.

If a searching operation is successfully completed, the dialogue history updating unit 204 deletes the user input information and the system response shown after the user input information which was renewed, and adds rerun information included in the response message to the end of the dialogue history. The window updating unit 207 replaces the dialogue after the user input information that was renewed with the dialogue obtained as a result of rerunning, i.e., the dialogue indicated by the rerun information, included in the response message.

FIG. 11 shows the processing result after the system executes the function indicated in the third example.

As shown in FIG. 11, the user input information 1001 shown in FIG. 10 is replaced with user input information 1101 renewed by the user, and accordingly, the system response 1005, user input information 1003, and system response 1004 shown in FIG. 10 are replaced with system response 1102, user input information 1103, and system response 1104. For example, when filtered by “Music programs” as in FIG. 10, the system response to the user input information, “Filtered by appearances by performer XX”, is “There are 2 programs”, whereas when filtered by “Variety programs” as in FIG. 11, the system response to the user input information, “Filtered by appearances by performer XX” is renewed as, “There are 10 programs”. As explained above, if the user input information is partially modified, the user input information subsequent to the modified user input information is rerun. Accordingly, the user does not have to input the same conditions for retrial of processing, searching, e.g., thus reducing inconvenience for the user.

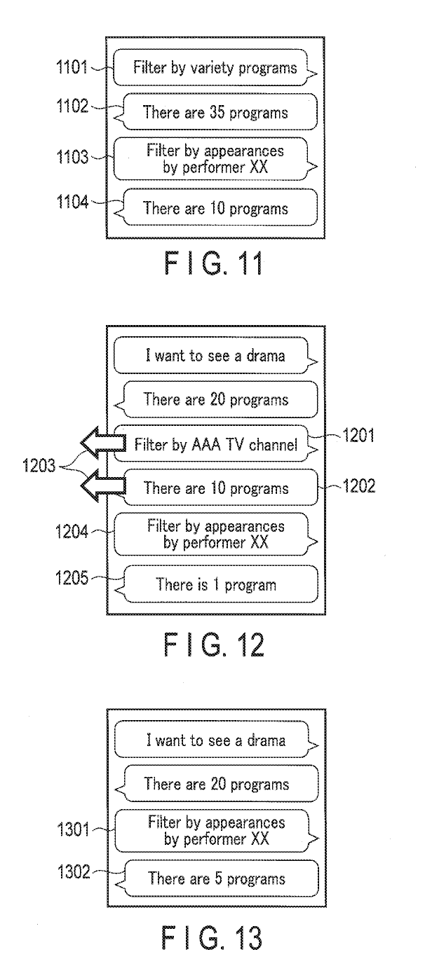

The fourth example of a user's operation will be explained with reference to FIGS. 12 and 13.

FIG. 12 is an example of a dialogue history displayed on the interface window, which is the same as FIG. 6. In this example, a swiping operation performed to a pair of user input information and a system response is associated with a function of “deleting the designated pair of user input information and system response, and the dialogue included in the dialogue history except the designated pair is rerun as much as possible” (“delete dialogue pair and rerun the other dialogue” in FIG. 3) in the function specification table. It is assumed that a pair of the user input information 1201, “Filter by AAA TV channel”, and the system response 1202, “There are 10 programs”, are swiped at the same time in the direction of arrow 1203.

The operation detector 205 detects the user's swiping operation, and the function specifying unit 206 determines the function corresponding to the swiping operation as “deleting the designated pair of user input information and system response, and the dialogue included in the dialogue history except the designated pair is rerun as much as possible” by referring to the function specification table.

The function specifying unit 206 acquires an identifier corresponding to the user input information 1201 and an identifier corresponding to the system response 1202, which the user has swiped from the dialogue history storage 203. The dialogue processor 202 generates a request message based on the corresponding function, and the identifiers of the objects of the function.

The dialogue processor 202 transmits the request message to the dialogue processing server, and receives a response message from the dialogue processing server. The received response message includes processing results responsive to the request. If the function is successfully completed, the response message includes the results of re-processing the user input information except the swiped pairing operation as much as possible.

In FIG. 12, after the processing in response to the user input information 1201, “Filter by AAA TV channel” is deleted, the server determines whether or not the user input information 1204, “Filter by appearances by performer XX”, which was input before the swiping operation can be processed, and proceeds with the user input information 1204 again when it is processable.

In this example, since the user input information before and after renewal is both for filtering, rerunning of the user input information that has already input before renewal can be performed. If the dialogue scenario is changed by renewal of the user input information, rerunning is not performed. If the function is successfully completed, the dialogue history updating unit 204 deletes the user input information and the system response after the deleted pair, and adds the result of rerunning (also referred to as rerun information) included in the response message to the end of the dialogue history.

The window updating unit 207 deletes the pair of dialogues designated by the user, and replaces the dialogues after the deleted pair with the user input information and system response included in the rerun information.

FIG. 13 shows the processing result after the system executes the function indicated in the fourth example. The window updating unit 207 replaces user input information 1204 and system response 1205, which have been input after the deleted pair, with user input information 1301 and system response 1302 corresponding to the rerun information included in the response message. As shown in FIG. 13, after the user input information and the system response that the user swiped are deleted, the dialogue except the deleted pair of dialogues is rerun if possible. Accordingly, the user does not have to input the same conditions again. This reduces inconvenience for the user.

The function that the function specifying unit 206 specifies is not limited to one function. If multiple functions are associated with an operation, the user may select a desired function.

According to the present embodiment, the dialogue history is updated in response to a user's operation that is associated with a dialogue processing function. This allows the user to re-do a dialogue, or perform a dialogue using the past dialogue by an instinctive user interface operation, thereby facilitating smooth dialogue.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A dialogue support apparatus, comprising:
a receiver that receives at least one input information item indicating a user's intention;
a processor that uses a dialogue processing system interpreting the user's intention and performing a process corresponding to the user's intention, and obtains at least one system response each indicating a response of the dialogue processing system to the input information item;
a storage that stores a dialogue history indicating a history of the input information item and the system response;
a detector that detects a user operation performed by the user;
a specifying unit that specifies the input information item and the system response in the dialogue history to which the user operation is performed if the user operation is associated with a predetermined function;
a first updating unit that updates the dialogue history in response to execution of the function corresponding to the input information item and the system response specified by the specifying unit; and
a second updating unit that updates a user interface in accordance with the dialogue history updated by the first updating unit.

2. The apparatus according to claim 1, wherein the function is to delete the specified input information item and a part of the dialogue history after the specified input information item.

3. The apparatus according to claim 1, wherein the function is to set a dialogue status of the dialogue history when the specified system response was shown as a present status.

4. The apparatus according to claim 1, wherein the function is to replace the specified input information item with an input information item that the user newly inputs, and to rerun possible processing to at least one input information item included after the specified input information in the dialogue history.

5. The apparatus according to claim 1, wherein the function is to delete the specified input information item and the specified system response, and to rerun possible processing to at least one input information item except the deleted input information item included in the dialogue history.

6. The apparatus according to claim 1, wherein the receiver performs a speech recognition to an utterance received from the user, and generates text obtained as a result of the speech recognition.

7. The apparatus according to claim 1, wherein the dialogue history includes an identifier of each of the input information item and the system response, and the specifying unit determines at least one of the input information item and the system response to which the function is to be performed by referring to the identifier.

8. A dialogue support method, comprising:
receiving at least one input information item indicating a user's intention;
obtaining at least one system response each indicating a response of a dialogue processing system to the input information item, by using the dialogue processing system interpreting the user's intention and performing a process corresponding to the user's intention;
storing, in a storage, a dialogue history indicating a history of the input information item and the system response;
detecting a user operation performed by the user;
specifying the input information item and the system response in the dialogue history to which the user operation is performed if the user operation is associated with a predetermined function;
updating the dialogue history in response to execution of the function corresponding to the input information item and the system response specified by the specifying unit; and
updating a user interface in accordance with the dialogue history updated by the first updating unit.

9. The method according to claim 8, wherein the function is to delete the specified input information item and a part of the dialogue history after the specified input information item.

10. The method according to claim 8, wherein the function is to set a dialogue status of the dialogue history when the specified system response was shown as a present status.

11. The method according to claim 8, wherein the function is to replace the specified input information item with an input information item that the user newly inputs, and to rerun possible processing to at least one input information item included after the specified input information in the dialogue history.

12. The method according to claim 8, wherein the function is to delete the specified input information item and the specified system response, and to rerun possible processing to at least one input information item except the deleted input information item included in the dialogue history.

13. The method according to claim 8, wherein the receiving the input information item performs a speech recognition to an utterance received from the user, and generates text obtained as a result of the speech recognition.

14. The method according to claim 8, wherein the dialogue history includes an identifier of each of the input information item and the system response, and the specifying determines at least one of the input information item and the system response to which the function is to be performed by referring to the identifier.

15. A non-transitory computer readable medium including computer executable instructions, wherein the instructions, when executed by a processor, cause the processor to perform a method comprising:
receiving at least one input information item indicating a user's intention;
obtaining at least one system response each indicating a response of a dialogue processing system to the information item, by using the dialogue processing system interpreting the user's intention and performing a process corresponding to the user's intention;
storing, in a storage, a dialogue history indicating a history of the input information item and the system response;
detecting a user operation performed by the user;
specifying the input information item and the system response in the dialogue history to which the user operation is performed if the user operation is associated with a predetermined function;
updating the dialogue history in response to execution of the function corresponding to the input information item and the system response specified by the specifying unit; and
updating a user interface in accordance with the updated dialogue history updated by the first updating unit.

16. The medium according to claim 15, wherein the function is to delete the specified input information item and a part of the dialogue history after the specified input information item.

17. The medium according to claim 15, wherein the function is to set a dialogue status of the dialogue history when the specified system response was shown as a present status.

18. The medium according to claim 15, wherein the function is to replace the specified input information item with an input information item that the user newly inputs, and to rerun possible processing to at least one input information item included after the specified input information in the dialogue history.

19. The medium according to claim 15, wherein the function is to delete the specified input information item and the specified system response, and to rerun possible processing to at least one input information item except the deleted input information item included in the dialogue history.

20. The medium according to claim 15, wherein the receiving the input information item performs a speech recognition to an utterance received from the user, and generates text obtained as a result of the speech recognition.
